(19) United States
(12) Patent Application Publication
(10) Pub. No.: US 2012/0146329 A1
(43) Pub. Date: Jun. 14, 2012

(54) PIPE CONNECTION ARRANGEMENT

(76) Inventor: Oscar McAven, Braak (DE)

(21) Appl. No.: 13/315,117

(22) Filed: Dec. 8, 2011

(30) Foreign Application Priority Data
Dec. 10, 2010 (DE) 10 2010 054 154.0
Dec. 27, 2010 (DE) 10 2010 056 448 6

(51) Int. Cl. F16L 21/02

(52) U.S. Cl. 285/374

(57) ABSTRACT

The invention relates to an arrangement for connecting pipe elements, comprising a first pipe element having at least one locking means arranged on the pipe inner wall, a second pipe element having an end section, wherein the second pipe element can be inserted into the first pipe at least in the region of the end section, a separate sealing means arranged at least in a part region of the end section to be completely surrounding its pipe outer wall, equipped to seal a connection between the first pipe element and the second pipe element, characterised in that the sealing means is equipped and designed at the same time as an arresting means to arrest the first and second pipe elements with each other while engaging the sealing means with the locking means.

### CROSS-REFERENCE TO RELATED APPLICATIONS

This application claims the benefit of German Patent Application No. 10 2010 054 154.0, filed on Dec. 10, 2010, entitled “PIPE CONNECTION ARRANGEMENT”, and German Patent Application No. 10 2010 056 448.6, filed on Dec. 27, 2010, entitled “PIPE CONNECTION ARRANGEMENT”, which are incorporated herein by reference.

### BACKGROUND OF THE INVENTION

1. The Field of the Invention

The present invention relates to an arrangement for connecting pipe elements, comprising a first pipe element having at least one locking means arranged on the pipe inner wall, a second pipe element with an end section, wherein the second pipe element can be inserted into the first pipe at least in the region of the end section, a separate sealing means arranged at least in a part region of the end section completely surrounding its pipe outer wall, equipped to seal a connection between the first pipe element and the second pipe element.

2. The Relevant Technology

Such arrangements are used in particular for connecting ventilation pipes. It is known to connect ventilation pipes of different diameter by inserting the pipe ends one into another. For pipes of the same diameter, in most cases the diameter of one of the pipe ends is reduced at least by the wall thickness of the corresponding other pipe so that they can be inserted into one another. The connection between the pipes is usually sealed by means of annular seals. In order to secure the connection against unintentional release, the connecting point is preferably secured by self-tapping screws, rivets or the like in the region of the overlapping pipe walls. A further type of pipe connection is known, for example from document EP 1 039 202 A1. A pipe connection for ventilation pipe systems is known from said document, in which an inner pipe element is introduced into an outer pipe element with tight fit. To seal the gap being produced between the inner and outer pipe element in the pushed-together state, a sealing lip surrounding the inner pipe element is provided. This sealing lip nestles against the inner side of the outer pipe element and thus seals the gap between both pipe elements. Both pipe elements automatically lock during insertion by means of annular embossing, which is provided on the outer pipe element, and a specially curved free end of the inner pipe element.

The disadvantage is that in the known pipe connections, after one-off connection of the pipes, the connection can no longer be released without the pipes or at least parts thereof having to be destroyed. Hence, on the one hand it is not possible for example in the pipe connection known from document EP 1 039 202 A1, after pushing together of two pipes, to release them from one another again. In order to be able to release the pipes connected to one another again from one another, it is necessary to drill out at least the annular embossing with the result of destroying the pipes or parts thereof. A further disadvantage consists in that the material surfaces of the connected pipe sections, in particular in the region of the locking, lie directly one on another. Due to the vibrations, there may be signs of wear and material fatigue in these regions so that permanent and reliable locking of the pipe connection cannot be guaranteed.

It is therefore the object of the present invention to propose an arrangement for connecting pipes which guarantees reliable, flexible and re-releasable connection of pipes.

### BRIEF SUMMARY OF THE INVENTION

The object is achieved by an arrangement having the features mentioned in the introduction in that the sealing means is equipped and designed at the same time as an arresting means to arrest the first and second pipe elements with each other while engaging the sealing means with the locking means. Hence, it is guaranteed that the material surfaces of the first pipe element and of the second pipe element are mechanically uncoupled via the sealing means or via the arresting means. Oscillations or vibrations are dampened on the one hand by the sealing means lying between the first and the second pipe element, on the other hand the material surfaces of the first pipe element and of the second pipe element may no longer rub directly one on another so that material fatigue is reliably avoided. A further advantage consists in that the connection can be released again without destruction as required.

A preferred development of the invention is characterised in that the sealing section in a non-inserted first position of the first and second pipe elements is arranged at least essentially vertically to the pipe outer wall of the second pipe element and in an inserted second position of the first and second pipe elements, is arranged on the sealing means base body to be designed and flexible such that the sealing section is inclined counter to the insertion direction of the second pipe element with sealing contact of a free limb of the sealing section with the pipe inner wall of the first pipe element. This has the advantage that the sealing section nestles as far as possible over the full surface against the pipe inner wall of the first pipe element and at the same time with a corresponding contact pressure force, which is caused by the bending of the sealing section in the inserted second position, is pressed against the pipe inner wall so that reliable sealing of the connection is achieved between the first pipe element and the second pipe element.

A further expedient design of the invention is characterised in that the arresting section is arranged on the sealing means base body spaced from the sealing section and has at least one sliding surface and one arresting surface. This is particularly advantageous, since the sliding surface enables insertion of the second pipe element into the first pipe element using only low expenditure of force, whereas the arresting section reliably secures the connection against unintentional release.

According to a further preferred design of the invention, the locking means is designed as embossing and/or stamping of the pipe wall of the first pipe element and has a sliding region to pass the arresting means along the locking means during insertion of the second pipe element from the first position to the second position, and a locking region to arrest the first and second pipe elements with each other in the second position. The sliding region in conjunction with the sliding surface of the sealing means or of the arresting means has the advantage of as low as possible expenditure of force when pushing together the first and second pipe elements.

A further preferred embodiment is characterised in that the locking region is equipped and designed at least partly to correspond to the arresting means such that the first and second pipe elements are arrested with each other in the second position by means of positive locking between the locking region and the arresting means.

A particularly advantageous design of the invention is characterised in that the locking region further comprises a guide region, wherein the guide region with at least one first side is arranged to be adjoining at least one part of the locking region. By means of the guide region, the connection of the first pipe element and of the second pipe element may be released again by rotating the first pipe element and the second pipe element relative to one another and simultaneous exertion of an only low tensile force in the opposite direction. However, release during action of a relatively low tensile force on the connection is possible only with simultaneous rotation of the first and second pipe elements so that the connection otherwise is reliably arrested and secured against unintentional release.

These and other objects and features of the present invention will become more fully apparent from the following description and appended claims, or may be learned by the practice of the invention as set forth hereinafter.

### BRIEF DESCRIPTION OF THE DRAWINGS

Further preferred and/or expedient features and designs of the invention can be seen from the sub-claims and the following description, in which particularly preferred embodiments are illustrated in more detail using the attached drawings as follows:

FIG. 1 is a longitudinal section of the arrangement for connecting two pipe elements according to a first design of the present invention in a non-inserted first position;

FIG. 2 is a longitudinal section of the arrangement according to the first design of the present invention when inserting from the first position to an inserted second position;

FIG. 3 is a longitudinal section of the arrangement according to the first design of the present invention in the inserted second position;

FIG. 4 is a longitudinal section of the arrangement according to the first design of the present invention in the second position during release of the connection;

FIG. 5 is a longitudinal section of the arrangement according to the first design of the present invention after release of the connection;

FIG. 6 is a part region view of FIG. 1 in the first position;

FIG. 7 is a part region view of FIG. 3 in the second position;

FIG. 8 is a part region view in the first position according to a second design of the invention;

FIG. 9 is a part region view in the second position according to the second design of the invention;

FIG. 10 is a part region view in the first position according to a third design of the invention;

FIG. 11 is a part region view in the second position according to the third design of the invention;

FIG. 12 is a part region view in the first position according to a fourth design of the invention;

FIG. 13 is a part region view in the second position according to the fourth design of the invention;

FIG. 14 is a part region view in the first position according to a fifth design of the invention;

FIG. 15 is a part region view in the second position according to the fifth design of the invention;

FIG. 16 is a schematic diagram during release of the connection between the first and second pipe elements;

FIG. 17 is a part region view in the first position according to a sixth design of the invention;

FIG. 18 is a part region view in the second position according to the sixth design of the invention;

FIG. 19 is a schematic diagram during release of the connection between the first and second pipe elements according to the sixth design of the invention;

FIG. 20 is a part region view in the first position according to a seventh design of the invention;

FIG. 21 is a part region view in the second position according to one variant of the sixth design of the invention; and

FIG. 22 is a part region view in the second position according to a still further variant of the sixth design of the invention.

### DETAILED DESCRIPTION OF THE PREFERRED EMBODIMENTS

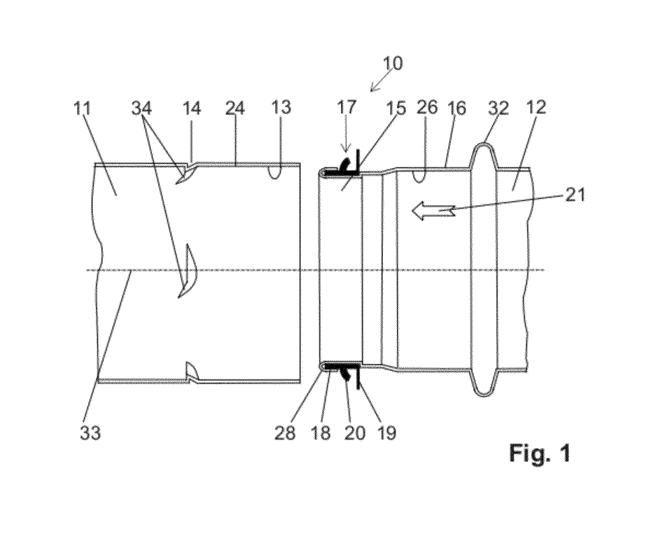

FIGS. 1 to 5 show a longitudinal section of the arrangement 10 according to a first exemplary embodiment of the present invention. The arrangement 10 comprises a first pipe element 11 and a second pipe element 12, wherein a locking means 14 is arranged on the pipe inner wall 13 of the first pipe element 11. Hence, also any number of locking means 14 may be provided on the pipe inner wall 13. The number depends in particular on the diameter of the first and second pipe elements 11, 12. The locking means 14 are preferably arranged to be in rotational symmetry with respect to a longitudinal axis 33 of the first or of the second pipe element 11, 12. The second pipe element 12 can be inserted into the first pipe element 11 in the region of an end section 15. Hence, the second pipe element 12 has in the region of the end section 15, an external diameter which is less than an internal diameter of the first pipe element 11. Of course it is also possible that the external diameter of the second pipe element 12 is selected to be less than the internal diameter of the first pipe element 11, that is, the external diameter of the second pipe element 12 at least essentially over the entire pipe length is constantly less so that in the region of the end section 15, a diameter reduction is not absolutely necessary. Alternatively, the first pipe element 11 is widened at least at one of its ends so that the second pipe element 12 is designed to be insertable into the first pipe element 11 in any case at least with the end section 15. Furthermore, the present invention is not restricted exclusively to circular pipe elements 11, 12. Rather, any cross-sectional shape of the pipe elements 11, 12 is suitable, for example pipes having oval, rectangular or polygonal cross-section.

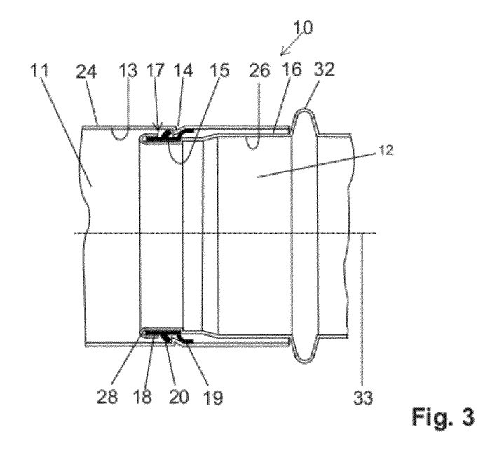

In at least one part region of the end section 15, a separate sealing means 17 is arranged to completely surround a pipe outer wall 16. The sealing means 17 is thus equipped and designed to seal a connection between the first pipe element 11 and the second pipe element 12. The sealing means 17 is preferably manufactured from a resilient plastic, for example from ethylene-propylene-diene rubber (EPDM). In addition to EPDM, the sealing means 17 may however also consist of further plastic or non-plastic connections or may be composed of a combination thereof, provided they are suitable to guarantee the sealing connection between the first pipe element 11 and the second pipe element 12. Alternatively, the separate sealing means 17 may be injection moulded onto the second pipe element 12, for example as a plastic moulding. Hence, the sealing means 17 may consist of one or more layers of one or more types of material. The sealing means 17 is designed at the same time as an arresting means. In an inserted first position shown in FIG. 3, arresting of the first pipe element 11 with the second pipe element 12 is effected while engaging the sealing means 17 with the locking means 14. Expressed differently, the sealing means 17 fulfils two functions. On the one hand the sealing means 17 seals the connection between the first pipe element 11 and the second pipe element 12 by resting on the pipe inner wall 13 at least in gas-tight and/or fluid-tight manner, on the other hand the sealing means 17 in its function as the arresting means arrests the first and second pipe elements 11, 12 with each other in that the sealing means 17 engages with the locking means 14. Slipping out or unintentional release of the connection between the first and the second pipe element 11, 12 is thus reliably avoided.

According to a preferred design of the invention, the sealing means 17 comprises a sealing means base body 18, at least one sealing section 19 and at least one arresting section 20. The sealing means base body 18 is designed, for example in the form of a sealing band or sealing ring and is arranged completely surrounding the pipe outer wall 16 of the second pipe element 12 at least in the part region of the end section 15. Hence, the sealing means base body 18 may extend either only over the part region of the end section 15 or over an entire outer wall region of the end section 15. The sealing means base body 18 is preferably arranged to surround with tight fit the pipe outer wall 16 of the second pipe element 12, in that the sealing means base body 18 has an at least somewhat shorter peripheral length than the pipe outer wall 16 of the second pipe element 12. The sealing section 19 and the arresting section 20 are arranged to be flexible on the sealing means base body 18.

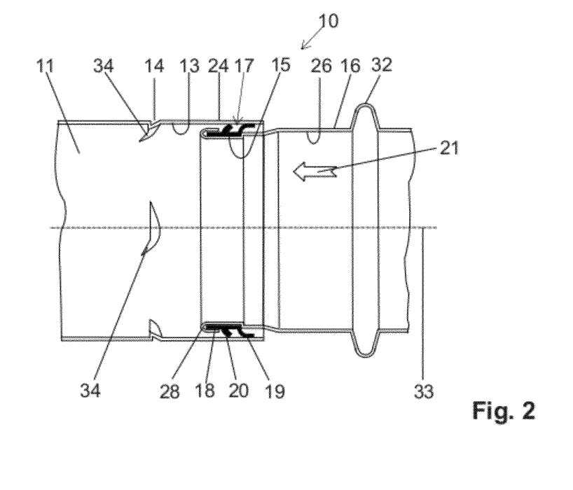

As shown in FIG. 2, the sealing section 19 or the arresting section 20 on introduction of the second pipe element 12 in an insertion direction 21, starting from the first position to an inserted second position due to the flexibility of the sealing section 19 and of the arresting section 20, are curved towards the second pipe element 12 and nestle against the pipe inner wall 13 of the first pipe element 11 with formation of corresponding sealing surfaces. Alternatively, it is also possible that the sealing section 19 and the arresting section 20 together are designed as a single sealing lip or arresting lip.

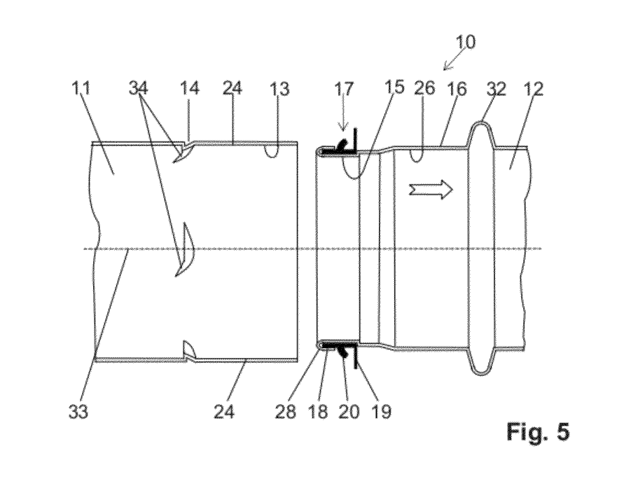

According to a further preferred design of the invention, the sealing section 19 and the arresting section 20, as shown in FIGS. 1 to 5, are each made as separate sections. The sealing section 19 in the non-inserted first position (see FIGS. 1 and 5) of the first and second pipe elements 11, 12 is particularly preferably arranged vertically or essentially vertically to the pipe outer wall 16. The sealing section 19 preferably has a height which is selected so that the sealing section 19 extends at least over the entire internal diameter of the first pipe element 11. By means of the flexible arrangement of the sealing section 19 on the sealing means base body 18, the sealing section 19 is arranged to be movable on the sealing means base body 18 such that during insertion of the second pipe element 12 into the first pipe element 11, the sealing section 19 is inclined counter to the insertion direction 21 (see FIGS. 2 and 3). The sealing section 19 is thus arranged to be flexible such that the sealing section 19 in a non-inserted first position is arranged vertically or essentially vertically to the pipe outer wall 16 of the second pipe element 12, whereas the sealing section 19 in an inserted second position or during the movement into this second position is inclined counter to the insertion direction 21. The inclination of the sealing section 19 counteracts a restoring force so that the sealing section 19 is therefore exposed to a corresponding contact pressure force and is pressed against the pipe inner wall 13 of the first pipe element 11. Hence, reliable sealing of the connection between the first and second pipe elements 11, 12 is guaranteed.

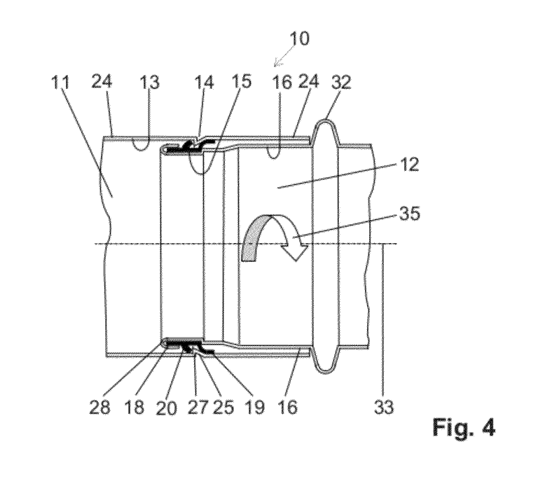

According to an advantageous development of the invention, the arresting section 20 arranged on the sealing means base body 18 is arranged spaced from the sealing section 19 and has a sliding surface 22 and a arresting surface 23. The sliding surface 22 is designed such that the locking means 14 slides over the arresting section 20 during insertion of the second pipe element 12 into the first pipe element 11 with low expenditure of force. In this manner the second pipe element 12 may be inserted relatively easy, that is, with relatively low expenditure of force, into the second pipe element 11. By means of the arresting surface 23 of the arresting section 20, the first and second pipe elements 11, 12 are arrested with each other in the inserted second position. Hence, the arresting surface 23 is designed such that it engages behind the locking means 14 so that during exposure of the first and second pipe elements 11, 12 to tensile forces in each case in opposite directions, slipping out of the second pipe element 12 from the first pipe element 11 is reliably avoided. In other words, the sliding surface 22 is designed such that it slides, if possible without considerable expenditure of force along the locking means 14 in the insertion direction 21, whereas the arresting surface 23 by means of engagement with the locking means 14 reliably prevents release of the connections between the first pipe element 11 and the second pipe element 12. Release of the connection may be achieved with simultaneous rotation of the second pipe element 12 relative to the first pipe element 11 and exposure of the first and second pipe elements 11, 12 to a correspondingly high tensile force in the direction of the longitudinal axis 33 (see FIGS. 4 and 5).

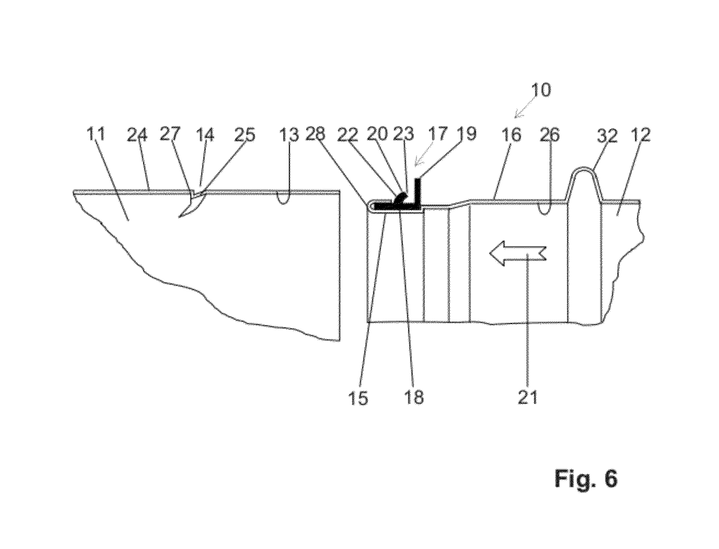

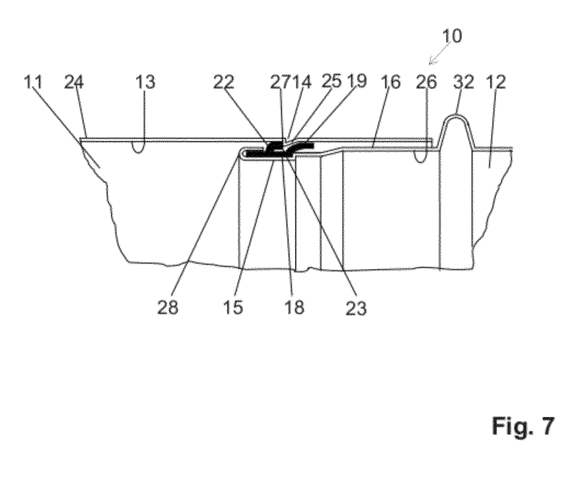

As can be seen from the part region views of FIGS. 6 and 7, the sealing section 19 and the arresting section 20 are arranged to be spaced from one another. The distance between the sealing section 19 and the arresting section 20 is preferably arranged so that the arresting section 20 may be deformed during sliding-over of the locking means 14 without coming into contact with the sealing section 19. In this manner, jamming of the arresting section 20 by the sealing section 19 is avoided, which in turn could result in an increased expenditure of force or possibly the danger of damage to the arresting section 20 or to the sealing section 19.

A preferred development of the invention is characterised in that the sliding surface 22 is designed to be inclined and/or curved with respect to a normal S to the pipe outer wall 16 or to the pipe inner wall 13 counter to the insertion direction 21. The sliding surface 22 thus extends, starting from the sealing means base body 18, either inclined and/or curved outwards. As can be seen in the part region view of FIGS. 6 and 7, the sliding surface 22 is preferably curved convexly. Alternatively, it is however also possible to design the sliding surface 22 to be concavely curved or to arrange the sliding surface 22 as a surface which is inclined with respect to the normal S. The inclination or curvature of the sliding surface 22 ensures that the second pipe element 12 can be inserted into the first pipe element 11 without considerable expenditure of force, since a clamping force acting between the locking means 14 and the sliding surface 22 increases only with further insertion depth of the second pipe element 12 due to the inclination or curvature of the sliding surface 22. The sliding surface 22 or the entire arresting section 20 may yield to this increasing clamping force within certain limits by deformation or by curving, so that the clamping force is held essentially at a constantly low level. If the second pipe section 12 reaches the second position (see FIG. 7) during insertion into the first pipe section 11, the arresting section 20 engages behind the locking means 14. Hence, the connection of the first and second pipe elements 11, 12 is reliably locked. If this connection of the first and second pipe elements 11, 12 is under tension, the arresting section 20 engaging behind the locking means 14 with the arresting surface 23 prevents unintentional release of the connection.

According to a further preferred design of the invention, the arresting surface 23 is designed to be inclined and/or curved with respect to the normal S to the pipe outer wall 16 counter to the insertion direction 21. In other words, the arresting surface 23 is inclined and/or curved opposite to the sliding surface 22. For example the sliding surface 22, as can be seen for example from FIGS. 6 and 7, is curved convexly from a viewing direction counter to the insertion direction 21, whereas the arresting surface 23 runs straight at least on a part region or is curved concavely. Alternatively, the sliding surface 22—for the same viewing direction—may be designed to be inclined outwards, whereas the arresting surface 23 is arranged to be inclined inwards. In this case, the sliding surface 22, the arresting surface 23 and an upper side of the adjoining sealing means base body 18 describe in section a triangular surface. Of course the arresting surface 23 may also be curved if the sliding surface 22 is, for example exclusively inclined and vice versa. Furthermore, the sliding surface 22 and the arresting surface 23 may each comprise several sections, wherein some of these sections are designed to be curved and other sections are designed to be inclined. It is also possible that the arresting surface 23 is equipped and designed at least in a part region to be at least essentially parallel to the pipe outer wall 16. The sealing means 17 is particularly preferably designed to be integral, that is, is manufactured from one piece, for example as an injection-moulded part or extruded part. As already described previously, the sealing means 17 may be formed integrally from different materials and/or may be arranged on the second pipe element 12 optionally by injection moulding.

According to a further preferred design of the invention, the locking means 14 is designed as embossing of the pipe wall 24 of the first pipe element 11. Furthermore, the locking means 14 has a sliding region 25 which is designed and equipped such that the sealing means 17 or the arresting means can be pushed along the locking means 14 during insertion of the second pipe element 12 from the first position to the second position. One possible design can be seen, for example from FIGS. 6 and 7. With viewing direction in the insertion direction 21, the sliding region 25 extends, starting from the pipe inner wall 13 of the first pipe element 11, inclined and/or curved towards the pipe centre. Expressed differently, the embossing of the pipe wall 24 forming the locking means 14 is directed in the direction of the longitudinal axis 33 of the first pipe element 11, wherein the sliding region 25 rises with respect to the pipe inner wall 13 continuously from the pipe inner wall 13 in the direction of the pipe centre or the longitudinal axis 33. A locking region 27 is connected preferably directly to the sliding region 25. The locking region 27 serves to arrest the first and second pipe elements 11, 12 in the second position, in which the arresting section 20 engages behind the locking region 27 of the locking means 14. Alternatively, at least one further transition region is arranged between the sliding region 25 and the locking region 27.

A further advantageous design of the invention makes provision in that the locking region 27 or at least one part of the locking region 27 is designed and equipped to correspond to the sealing means 17 or the arresting means. In this manner, the first and second pipe elements 11, 12 are arrested in the second position by means of positive locking between the locking region 27 and the arresting means. At least the locking region 27 is preferably designed to correspond to the arresting surface 23. If the connection of the first and second pipe elements 11, 12 is under tension, the arresting surface 23 rests at least partly flatly, particularly preferably flatly to the greatest possible extent, on the locking region 27 and thus facilitates optimum transfer of force of the corresponding tensile force from the arresting surface 23 to the locking region 27 while avoiding a high area, line or point load, which could optionally lead to a deformation or optionally to permanent damage to the sealing means 17 or to the arresting means.

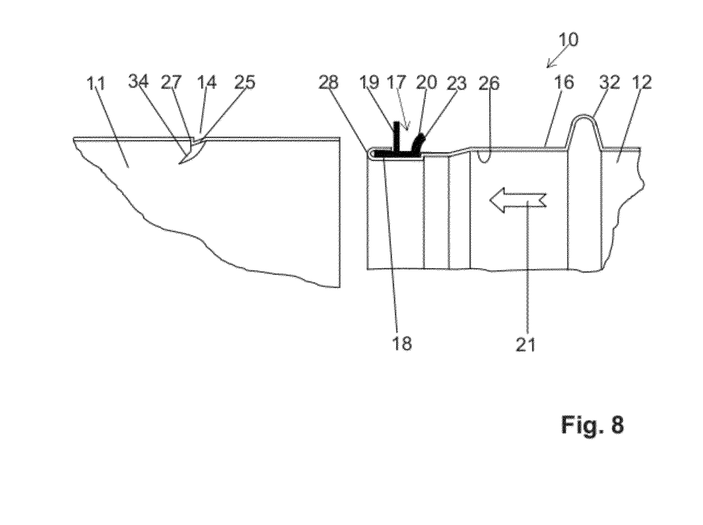

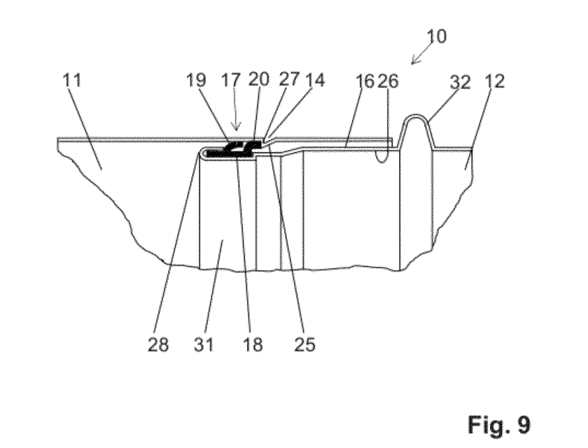

FIGS. 8 and 9 show a second preferred embodiment of the invention which differs from the first embodiment shown in FIGS. 1 to 7 in that the positions of the sealing section 19 and the arresting section 20 are reversed with respect to the positions of the first embodiment. During insertion of the second pipe element 12 into the first pipe element 11, therefore initially the sealing section 19 is slid along the locking means 14 before then the arresting section 20 engages behind the locking means 14 and the first and second pipe elements 11, 12 arrest with each other.

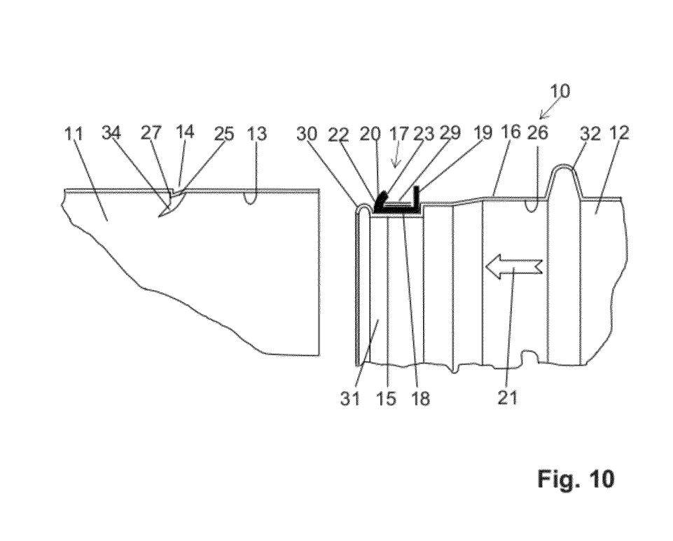

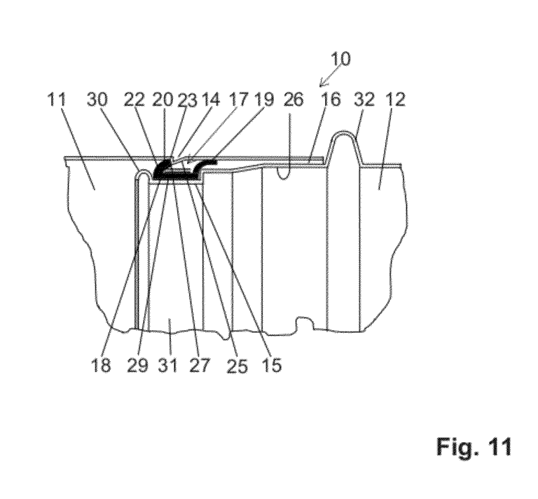

FIGS. 10 and 11 show a third embodiment of the invention which differs from the embodiment shown in FIGS. 1 to 7 exclusively in the attachment of the sealing means 17 or of the arresting means. According to the first embodiment, the sealing means 17 or the arresting means is held by means of clamping. Hence, the second pipe element 12 is provided on the end of the end section 15 with a beaded edge 28. A part region of the sealing means 17 or of the sealing means base body 18 is clamped below this beaded edge 28. In addition, the beaded edge 28 prevents slipping of the sealing means 17 or arresting means on exposure to forces in longitudinal axial direction, that is, on exposure to forces in or counter to the insertion direction 21. The second embodiment shown in FIGS. 8 and 9 differs from this with respect to the first embodiment in that the sealing means 17 or the arresting means is arranged non-positively on the second pipe element 12 by means of an annular clamping ring 29. In order to secure the sealing means 17 or the arresting means additionally against longitudinally axial slipping, an end bead 30 is optionally provided on the end section 15 which secures in supplementary manner the sealing means 17 or the arresting means positively against slipping in longitudinally axial direction. The second pipe element 12 preferably has a region 31 with reduced external diameter with respect to the further regions of the second pipe element 12 so that the sealing means 17 or the sealing means base body 18 in this region 31 with reduced external diameter is arranged to be additionally held positively. Alternatively, it is also possible that the positions of the sealing section 19 and the arresting section 20 are reversed, corresponding to the second embodiment shown in FIGS. 8 and 9.

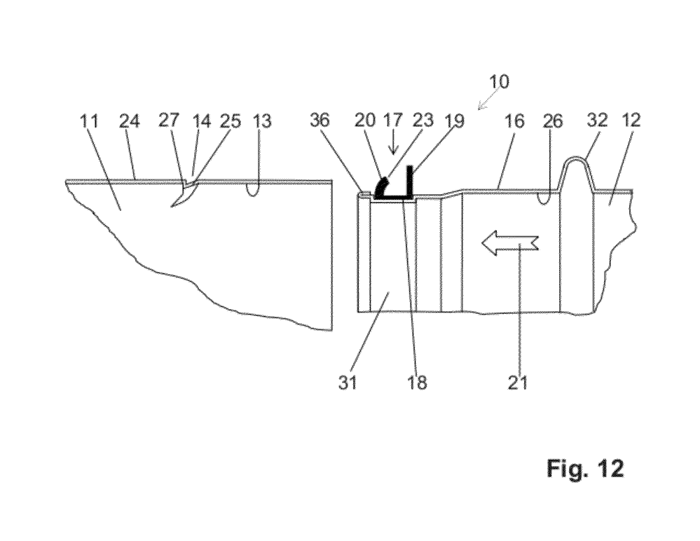

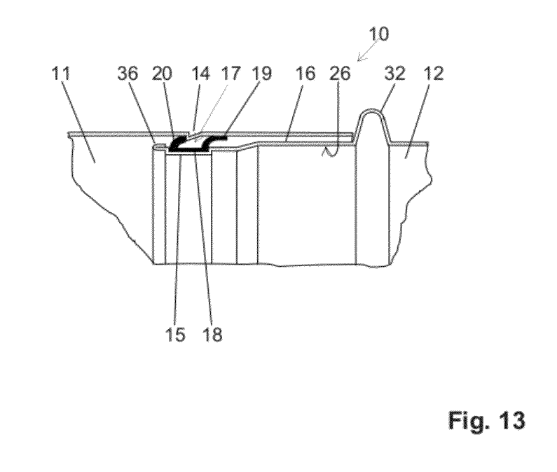

A fourth embodiment of the invention is shown in FIGS. 12 and 13. This embodiment corresponds to the third embodiment shown in FIGS. 10 and 11, but with the difference that the sealing means 17 or the arresting means is arranged on the end section 15 exclusively by positive locking. Of course it is also possible to secure the sealing means 17 or the arresting means in supplementary manner using an annular clamping ring 29 not shown in FIGS. 12 and 13. The end section 15 is particularly preferably designed and equipped as a fold 36 on the end side.

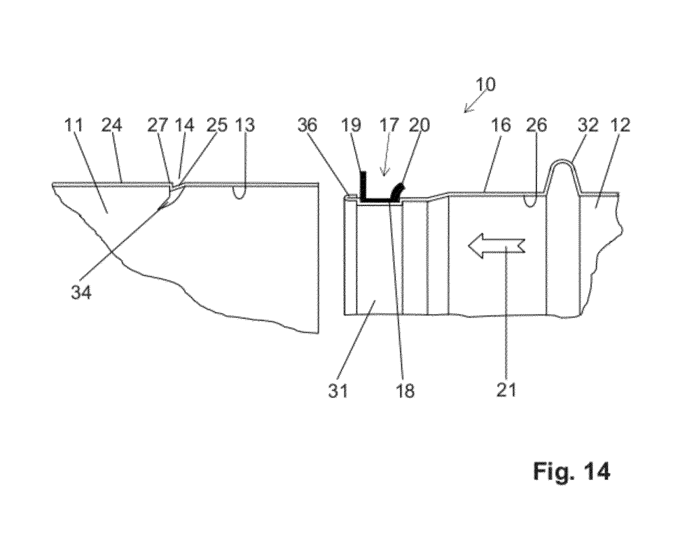

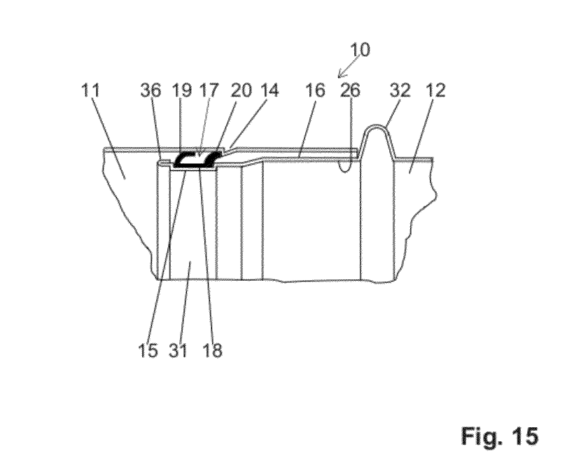

FIGS. 14 and 15 show a fifth embodiment which corresponds to the fourth embodiment shown in FIGS. 12 and 13, but, analogously to the third embodiment (see FIGS. 10 and 11), the positions of the sealing section 19 and of the arresting section 20 are reversed here accordingly. To avoid repetition, reference is made to the corresponding text passages of the description of the third embodiment.

Of course the present invention is not restricted to the afore-mentioned embodiments, but rather encompasses any combination of individual features of the embodiments described. In all embodiments it may be expedient to arrange the sealing means 17 or the arresting means on the end section 15 exclusively or additionally by means of an adhesive connection. The second pipe element 12 preferably comprises a limiting bead 32 which is arranged, for example as an outwardly embossed bead on the second pipe element 12. The limiting bead 32 serves as an end arrest which fixes the maximum insertion depth of the second pipe element 12 in the first pipe element 11.

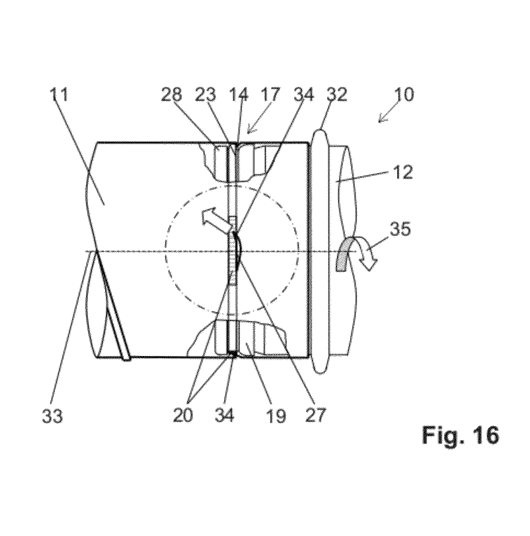

FIG. 16 shows a schematic diagram when releasing the connection of the first and second pipe elements 11, 12 according to a further preferred embodiment of the invention. All afore-mentioned embodiments preferably comprise the features below of this further preferred embodiment. This further embodiment is characterised in that the locking region 27 further comprises a guide region 34. For better understanding of the mode of operation of the guide region 34, the arresting section 20 in FIG. 16 is provided with transverse shading. Furthermore, the first pipe element 11 is shown partly transparent so that it can be seen from FIG. 16 how the guide region 34 engages behind the arresting section. The guide region 34 is arranged with at least a first side adjoining at least one part of the locking region 27. If the first and second pipe elements 11, 12 are under tension, the sealing means 17 or the arresting means rests with its arresting surface 23 on the locking means 14. At the same time, the guide region 34, due to its arrangement on the locking region 27, engages at least on one part section via the arresting means, that is, the sealing means 17 or the arresting means is pressed in the direction of the pipe outer wall 16 of the second pipe element 12. By rotating the second pipe element 12 in a direction of rotation 35 relative to the first pipe element 11, the guide region 34 “presses” the arresting means over the region between the sliding surface 22 and the arresting surface 23 of the arresting means. By further rotation of the second pipe element 12 relative to the first pipe element 11 in the direction of rotation 35, with simultaneous exposure of the first and second pipe elements 11, 12 to a corresponding tensile force, the annular arresting means and or the sealing means 17 is passed gradually over the region between the sliding surface 22 and the arresting surface 23. After a maximum half rotation of the second pipe element by 180°, the arresting means is guided in any case over its entire peripheral length over the locking means 14 counter to the insertion direction 25, so that the connection of the first and second pipe section 11, 12 is released again. The guide region 34, starting from the one side, is preferably designed to be tapered. Hence, the guide region 34 may be designed, for example as an acute-angled triangular surface. However, any other tapered surface is also suitable as a guide region 34. The guide region 34 is particularly preferably aligned to be inclined with respect to the longitudinal axis 33 of the first pipe element 11. This inclined alignment of the guide region 34 ensures that the guide region 34 at the same time fulfils a guiding function, in that the guide region 34, due to the inclined position, guides the arresting means over the locking means 14 and at the same time prevents slipping back of the arresting means into the previous starting position to ensure in any event release of the connection of the first and second pipe elements after a half rotation of 180°. The angle of rotation required to release the connection is essentially dependent on the alignment of the guide region 34. A large angle of rotation to release the connection is necessary when the guide region 34 is aligned essentially parallel to the longitudinal axis 33, whereas this is reduced accordingly with a greater inclined position of the guide region 34 with respect to the longitudinal axis 33.

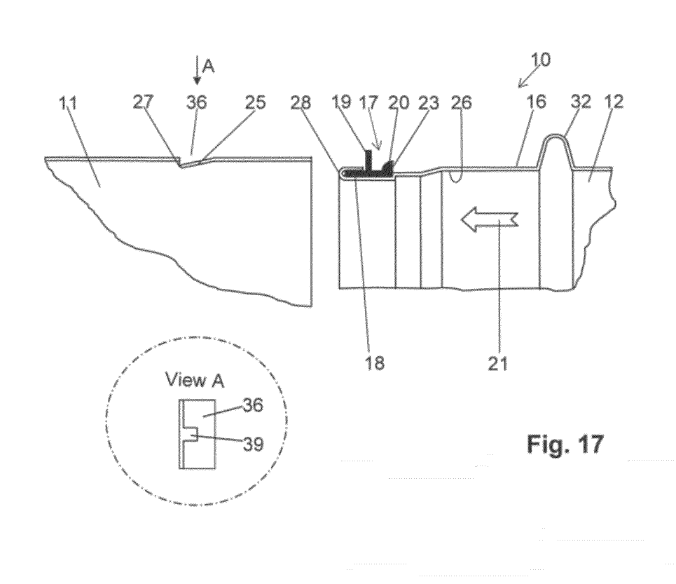

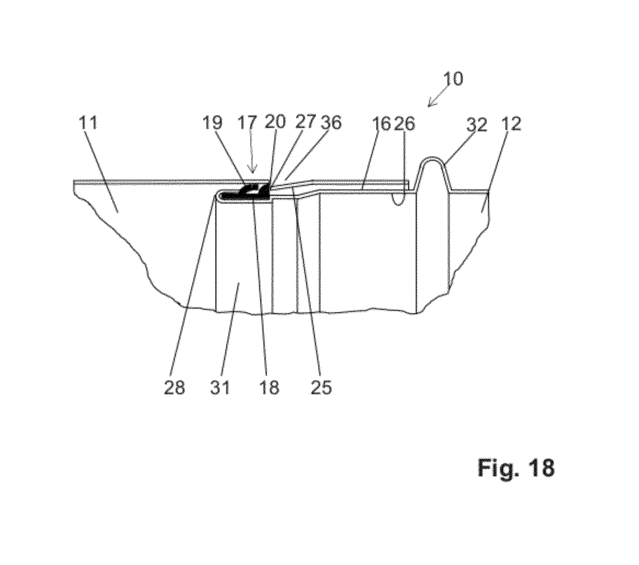

FIGS. 17 to 22 show a preferred alternative sixth design of the invention. This sixth embodiment of the invention corresponds in principle to the second design shown in FIGS. 8 and 9, but with the difference that the locking means 14 is designed as stamping 36 of the pipe wall 24 of the first pipe element 11. Of course it is also possible that the locking means 14, as shown enlarged in FIG. 17 in view A, comprises a combination of embossing and one or more cases of stamping 36. Hence, the locking means 14 shown in FIG. 17 has, for example stamping 36 in U shape, and is provided additionally with embossing in the direction of the pipe interior so that the locking means 14 is designed as a notch, as can also be seen in FIG. 18 in the inserted state.

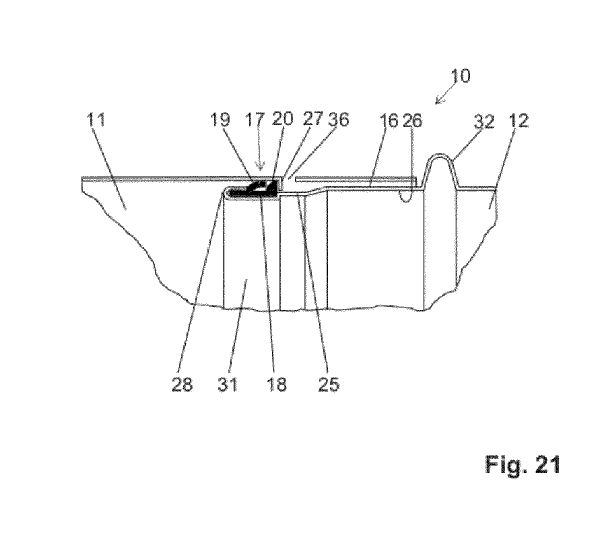

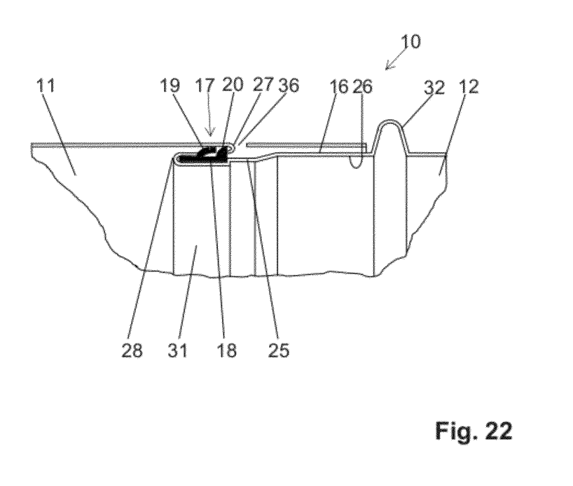

FIGS. 21 and 22 show alternative designs for stamping 36 in conjunction with embossing. In the alternative shown in FIG. 21, after stamping is completed, first of all the pipe element 12 must be inserted into the pipe element 11 before the stamped-out catch of the pipe wall 24 of the first pipe element may be curved around the arresting section 20 of the sealing means 17. In the alternative shown in FIG. 22, as also in the case of the alternative shown in FIG. 18, stamping and embossing may be effected in one working step before the pipe element 12 is inserted into the pipe element 11.

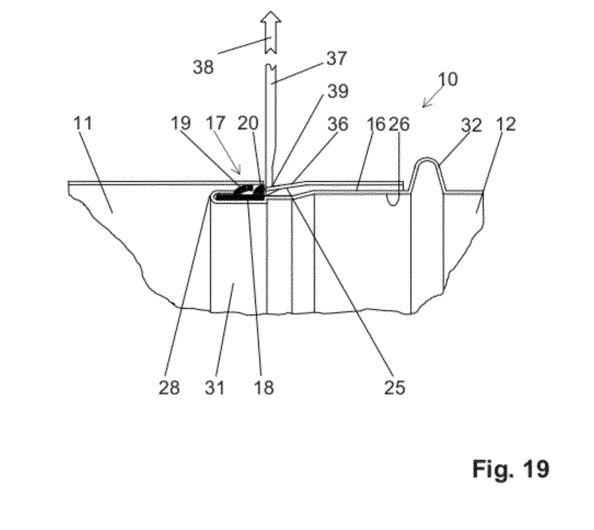

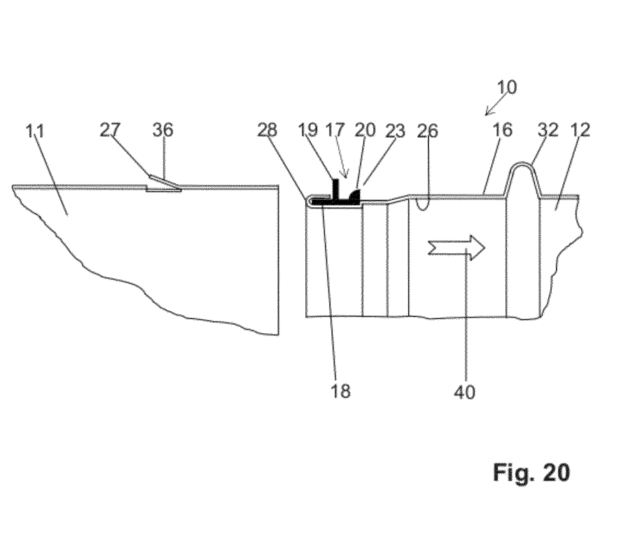

As shown in FIG. 19, this pipe connection may be released again by means of a suitable tool 37. Hence, the tool 37 is engaged with the locking means 14 and moved in a direction 38 so that the notch is curved in the direction 38 until it releases the sealing means 17 or the arresting means so far that the pipe connection may be separated again. Accordingly, the connections of the alternatives shown in FIGS. 21 and 22 can also be released again by a tool 37 with a suitable movement. FIG. 20 shows the sixth design after release of the connection has taken place.

Of course it is alternatively also possible to design the locking means 14 exclusively as stamping.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An arrangement for connecting pipe elements, comprising:
a first pipe element having at least one locking means arranged on the pipe inner wall,
a second pipe element having an end section, wherein the second pipe element can be inserted into the first pipe at least in the region of the end section,
a separate sealing means arranged at least in a part region of the end section to be completely surrounding its pipe outer wall, equipped to seal a connection between the first pipe element and the second pipe element, wherein the sealing means is equipped and designed at the same time as an arresting means to arrest the first and second pipe elements with each other while engaging the sealing means with the locking means.

2. An arrangement according to claim 1, characterised in that the sealing means comprises a sealing means base body, at least one sealing section and at least one arresting section.

3. An arrangement according to claim 2, characterised in that the sealing section in a non-inserted first position of the first and second pipe elements is arranged at least essentially vertically to the pipe outer wall of the second pipe element and in an inserted second position of the first and second pipe elements is arranged on the sealing means base body to be designed and flexible such that the sealing section is inclined counter to the insertion direction of the second pipe element with sealing contact of a free limb of the sealing section with the pipe inner wall of the first pipe element.

4. An arrangement according to claim 2, characterised in that the arresting section is arranged on the sealing means base body spaced from the sealing section and has at least one sliding surface and one arresting surface.

5. An arrangement according to claim 4, characterised in that the sliding surface is designed to be inclined and/or curved with respect to a normal S to the pipe wall counter to the insertion direction.

6. An arrangement according to claim 4, characterised in that the arresting surface is designed to be inclined and/or curved with respect to the normal S to the pipe wall in the insertion direction.

7. An arrangement according to claim 1, characterised in that the sealing means is designed to be integral.

8. An arrangement according to claim 1, characterised in that the locking means is designed as embossing and/or stamping of the pipe wall of the first pipe element and has a sliding region to pass sealing means or the arresting means along the locking means during insertion of the second pipe element from the first position to the second position, and a locking region to arrest the first and second pipe elements with each other in the second position.

9. An arrangement according to claim 8, characterised in that the locking region is equipped and designed at least partly to correspond to the arresting means such that the first and second pipe elements are arrested with each other in the second position by means of positive locking between the locking region and the arresting means.

10. An arrangement according to claim 8, characterised in that the locking region further comprises a guide region, wherein the guide region with at least one first side is arranged to be adjoining at least one part of the locking region.

11. An arrangement according to claim 10, characterised in that the guide region, starting from the one side, is designed to be tapered.

12. An arrangement according to claim 10, characterised in that the guide region is aligned to be inclined with respect to a longitudinal axis of the first pipe element.
